(19) United States
(12) Patent Application Publication
(10) Pub. No.: US 2026/0172516 A1
(43) Pub. Date: Jun. 18, 2026

(54) IMAGE PROCESSING APPARATUS, CONTROL METHOD FOR IMAGE PROCESSING APPARATUS, AND STORAGE MEDIUM

(71) Applicant: CANON KABUSHIKI KAISHA, Tokyo (JP)

(72) Inventor: HIROAKI KOBAYASHI, Kanagawa (JP)

(21) Appl. No.: 19/402,335

(22) Filed: Nov. 26, 2025

(30) Foreign Application Priority Data
Dec. 16, 2024 (JP) 2024-220218

(51) Int. Cl. H04N 1/00

(52) U.S. Cl. CPC H04N 1/00811; H04N 1/0044; H04N 1/00482; H04N 2201/0094

(57) ABSTRACT

An image forming apparatus includes at least one memory storing instructions, and at least one processor that, upon execution of the stored instructions, configures the at least one processor to operate as: a scanning unit configured to scan a document and generate image data, a display unit configured to display first image data generated by scanning a front side of the document with the scanning unit, wherein the display unit displays an object for treating the first image data as back-side data while displaying the first image data, and a control unit configured to treat second image data generated by scanning a back side of the document with the scanning unit as front-side data and treat the first image data as the back-side data when the object is selected.

### BACKGROUND

### Field of the Technology

The present disclosure relates to an image processing apparatus having a driving unit, a control method for the image processing apparatus, and a storage medium.

### Description of the Related Art

An image forming apparatus includes a physical driving unit and implements functions by controlling the driving unit. For example, an image forming apparatus includes driving units, such as a scanner and a printer. The image forming apparatus implements a copying function by reading a document with the scanner to generate image data and printing the image data on a sheet with the printer.

In the image forming apparatus, images read by the scanner can be output in the order in which they were read. In addition, Japanese Patent Laid-Open No. 9-102835 describes a technique of copying a saddle-stitched or center-folded booklet-type document and rearranging the page order for printing.

However, Japanese Patent Laid-Open No. 9-102835 is directed to saddle-stitched or center-folded booklet-type documents and does not address cases in ordinary copying where the front and back sides of a document are scanned in the wrong order. When the front and back sides of a document are scanned in the wrong order, it is necessary to cancel the job and rescan in the correct order, which is troublesome and inconvenient for the user.

### SUMMARY

The present disclosure is directed to improving usability by eliminating the need to rescan even when the front and back sides of a document are scanned in the wrong order.

According to an aspect of the present disclosure, an image processing apparatus includes at least one memory storing instructions, and at least one processor that, upon execution of the stored instructions, configures the at least one processor to operate as: a scanning unit configured to scan a document and generate image data, a display unit configured to display first image data generated by scanning a front side of the document with the scanning unit, wherein the display unit displays an object for treating the first image data as back-side data while displaying the first image data, and a control unit configured to treat second image data generated by scanning a back side of the document with the scanning unit as front-side data and treat the first image data as the back-side data when the object is selected.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration of an image forming apparatus.

FIG. 2 is a block diagram illustrating a software configuration of the image forming apparatus.

FIG. 3 is a flowchart illustrating processing of the image forming apparatus according to one or more aspects of the present disclosure.

FIGS. 4A to 4C illustrate examples of operation screens of the image forming apparatus according to one or more aspects of the present disclosure.

FIG. 5 is a flowchart illustrating processing of the image forming apparatus according to one or more aspects of the present disclosure.

FIG. 6A to 6D illustrate examples of operation screens of the image forming apparatus according to one or more aspects of the present disclosure.

### DESCRIPTION OF THE EMBODIMENTS

Hereinafter, embodiments for implementing the present disclosure will be described in detail with reference to the drawings. However, the components described in these embodiments are merely examples and are not intended to limit the scope of the disclosure to these components alone.

### First Embodiment

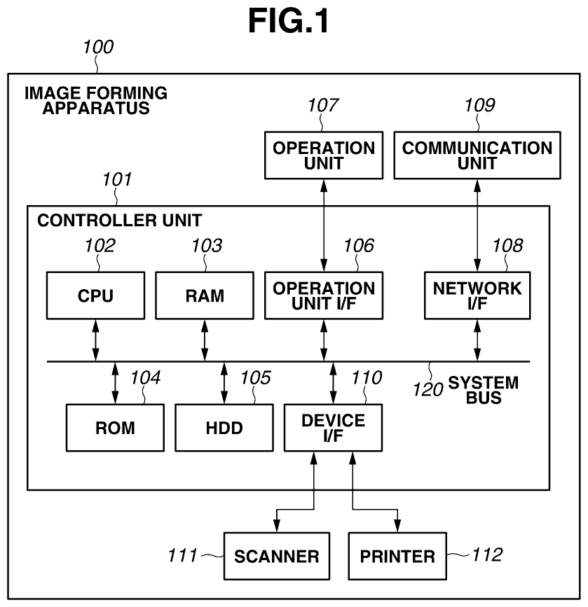

FIG. 1 is a block diagram illustrating a hardware configuration of an image forming apparatus 100 according to the present embodiment.

The image forming apparatus 100 includes a controller unit 101, and the controller unit 101 controls a scanner 111, a printer 112, an operation unit 107, and a communication unit 109. When a user uses a copying function, the controller unit 101 controls the scanner 111 to acquire image data from a document and controls the printer 112 to print and output the image on a sheet.

When a user uses a scanning function, the controller unit 101 controls the scanner 111 to acquire image data from a document, converts the image data into coded data, and transmits the coded data to an external device (not shown) via the communication unit 109. A processing instruction for executing each function is referred to as a job, and the image forming apparatus 100 executes predetermined processing according to a job corresponding to each function.

The controller unit 101 includes a central processing unit (CPU) 102, a random access memory (RAM) 103, a read only memory (ROM) 104, a hard disk drive (HDD) 105, an operation unit interface (I/F) 106, a network I/F 108, and a device I/F 110, all of which are connected via a system bus 120.

The CPU 102 controls the entire system of the image forming apparatus 100. The RAM 103 serves as a system working memory for the CPU 102 and as an image memory for temporarily storing image data.

In the RAM 103, programs, such as an operating system, system software, and application software, and data are placed. In addition, the RAM 103 stores scanned image data read by the scanner 111 and print data received from a data processing device via a network. The ROM 104 stores a boot program for the system. The hard disk drive (HDD) 105 stores the operating system, system software, application software, print data, setting data, and the like.

The operation unit I/F 106 serves as an interface with the operation unit 107 and outputs, to the operation unit 107, information to be displayed on the operation unit 107. The operation unit I/F 106 also receives information input by the user via the operation unit 107.

The network I/F 108 is connected to the communication unit 109 and performs various communication controls with external devices. The device I/F 110 connects the scanner 111 and the printer 112, which execute image reading and printing, to the controller unit 101 to perform input and output of image data.

The scanner 111 includes a document table and reads a document placed on the document table to generate image data.

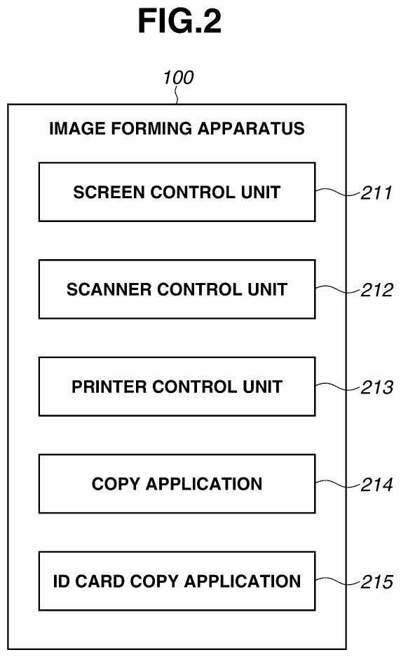

FIG. 2 is a block diagram illustrating a software configuration of the image forming apparatus 100 according to the present embodiment. Each block in FIG. 2 represents software stored in the ROM 104 or the HDD 105, which is read into the RAM 103 and executed by the CPU 102 to implement the processing in the flowcharts described below.

A screen control unit 211 controls the operation unit 107 via the operation unit I/F 106. The screen control unit 211 receives information input by the user through the operation unit 107 and generates screens to be displayed on the operation unit 107.

A scanner control unit 212 controls the scanner 111 via the device I/F 110 to read a document placed on the document table to generate image data.

A printer control unit 213 controls the printer 112 via the device I/F 110 to print image data on a sheet for output.

A copy application 214 is an application that implements the copying function.

An ID card copy application 215 is an application that implements an ID card copying function. The ID card copying function scans the front and back sides of an ID card and outputs them on a single sheet of paper. In the present embodiment, the ID card copying function is configured as an independent application, but this is merely an example and not limiting. The ID card copying function may also be provided as one function of the copy application.

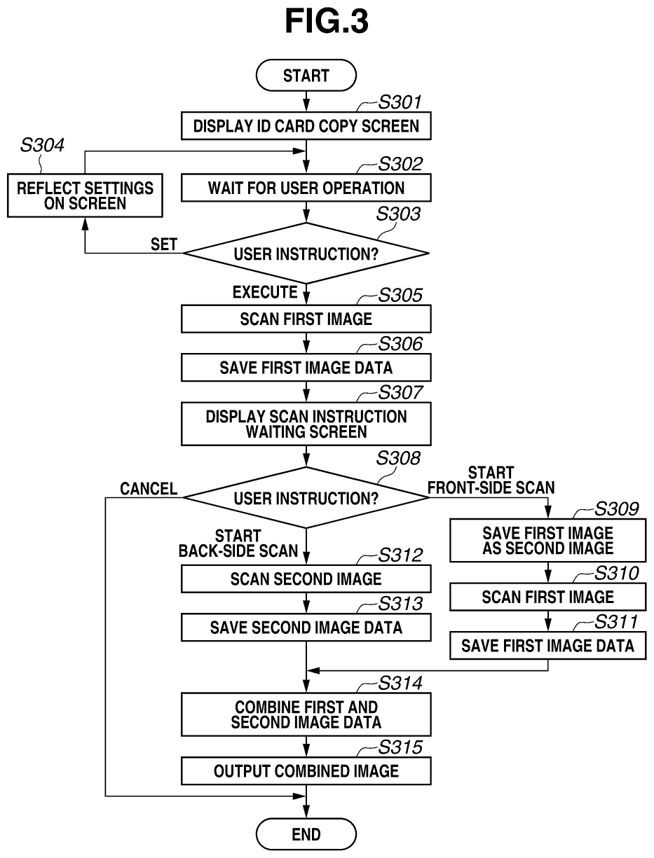

FIG. 3 is a flowchart illustrating processing of the ID card copying function executed by the image forming apparatus 100 according to the present embodiment. The flowchart in FIG. 3 is implemented by the CPU 102 of the image forming apparatus 100 reading programs for implementing each software module stored in the ROM 104 or the HDD 105 into the RAM 103 and executing the programs.

The flowchart in FIG. 3 starts by the screen control unit 211 detecting that the user has issued an instruction to call the ID card copy application 215 on a menu screen (not shown) displayed on the operation unit 107 and then starting the ID card copy application 215.

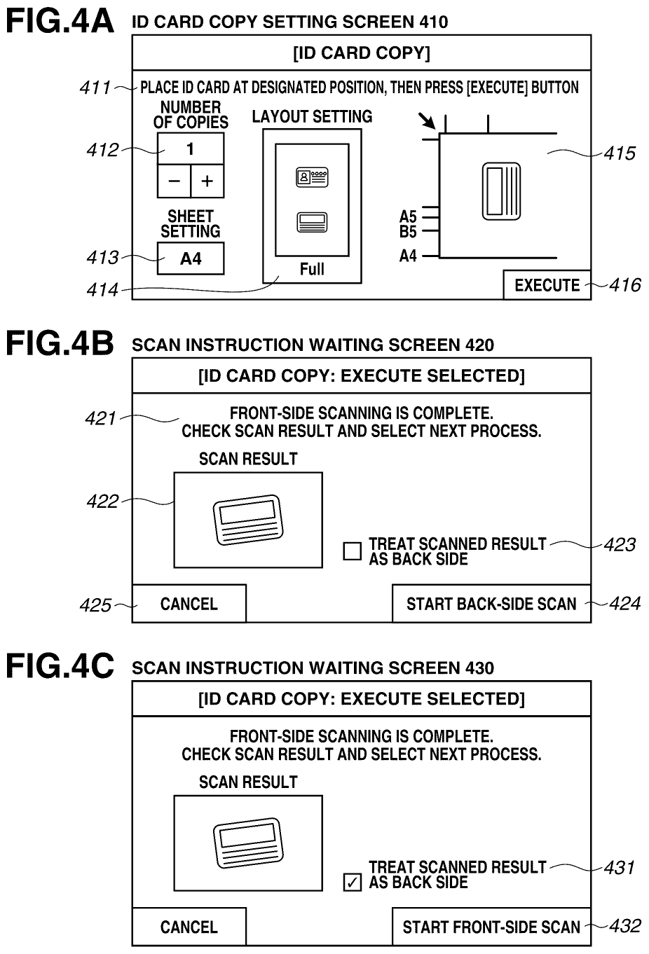

In step S301, the ID card copy application 215 displays an ID card copy setting screen 410 illustrated in FIG. 4A on the operation unit 107 via the screen control unit 211.

The ID card copy setting screen 410 includes a message area 411, a copy count setting 412, a sheet size setting 413, a layout setting 414, a guide display 415, and an execution button 416.

The message area 411 is an area for displaying messages that assist the user in operation.

The copy count setting 412 is a component for displaying and setting the number of copies to be printed. The user changes the setting for the number of copies using the “+” button and the “−” button. The sheet size setting 413 is a component for displaying and setting the size of the print sheet.

The sheet size setting 413 is a button that, when pressed, displays a screen (not shown) for selecting the print sheet size.

The layout setting 414 is a component for displaying and setting how the front and back sides of the ID card are arranged on the print sheet. The layout setting 414 is a button that, when pressed, displays a screen (not shown) for selecting the layout setting.

In the present disclosure, a first image and a second image are arranged at predetermined positions based on the layout setting and the like. The predetermined positions may be considered as the printing order of the first image and the second image. The first image and the second image may be printed on one page of print paper, on both sides of one sheet of print paper, or on separate sheets of print paper. In short, any configuration that arranges the first image and the second image as a combined image at predetermined positions or prints them in a predetermined order is acceptable.

The guide display 415 is used for displaying guidance indicating where to place the ID card on the document table. The guide display 415 updates the position of the ID card appropriately according to each setting.

Returning to the description of the flowchart, in step S302, the ID card copy application 215 waits for user operation via the screen control unit 211.

In step S303, if the detected user instruction is “to set” (SET in step S303), the ID card copy application 215 advances the processing to step S304. If the detected user instruction is “to execute” (EXECUTE in step S303), the ID card copy application 215 advances the processing to step S305. The user instruction “to set” refers to operations for setting the copy function, such as increasing or decreasing the number of copies using the copy count setting 412 and selecting the sheet size on the screen (not shown) displayed after pressing the sheet size setting 413.

In step S304, the ID card copy application 215 reflects the setting value(s) set by the user operation(s) on the screen, and the processing returns to step S302.

The user instruction “to execute” corresponds to pressing the execution button 416. For example, in addition to pressing the execution button 416, pressing a physical execution button provided on the operation unit 107 may also be acceptable.

In step S305, the ID card copy application 215 starts scanning the first image (instruction to acquire the first image; the acquired image is the first image) with the scanner 111 via the scanner control unit 212.

In step S306, the ID card copy application 215 stores, in the RAM 103, the first image data obtained by scanning in step S305.

In step S307, the ID card copy application 215 displays a scan instruction waiting screen 420 illustrated in FIG. 4B.

The scan instruction waiting screen 420 includes a message area 421, a scan result display area 422, a scan result order setting 423, a scan start button 424, and a cancel button 425.

The message area 421 is an area for displaying messages that assist the user in operation.

The scan result display area 422 displays the scanned image data saved in step S306 (image preview display). This allows the user to check the result immediately after the scan. Therefore, if the user has mistakenly scanned the back side first, the user can quickly notice the error.

The scan result order setting 423 is a check button for setting whether to change the output order of the scanned image saved in step S306. A screen displayed when the check is turned ON is illustrated in FIG. 4C as a scan instruction waiting screen 430, as described below.

The scan start button 424 issues an instruction to execute the next scan (instruction to acquire the second image; the acquired image is the second image). This instruction is given after acquiring the first image. Thus, the scanned image data is displayed between completion of scanning of the first image and the instruction to execute the next scan being issued, and the button for issuing the instruction to execute the next scan may be displayed simultaneously with the scanned image data.

By displaying the scanned image data, the check button, and the scan start button 424 simultaneously, the user can notice that the next scanned side of the document can be treated as the first image even if the wrong side of the document has previously been scanned, allowing the user to continue the operation without canceling the operation.

Since the scan result order setting 423 is OFF, the scan start button 424 displays text indicating that the next scan will read the back side of the ID card. In the present embodiment, the text of the scan start button 424 indicates which side of the ID card should be scanned next, but the scan start button 424 may simply display text indicating scan start.

The scan instruction waiting screen 430 (FIG. 4C) is displayed when the scan result order setting 423 is set to ON, as a result of updating the display of the scan instruction waiting screen 420 (FIG. 4B).

The scan result order setting 431 is displayed with the check button turned ON.

The scan start button 432 issues an instruction to execute the next scan.

The scan start button 432 displays text indicating that the next scan will read the front side of the ID card. In the present embodiment, the text of the scan start button 432 indicates which side of the ID card should be scanned next, but the scan start button 432 may simply display text indicating scan start.

Returning to the description of the flowchart, in step S308, the ID card copy application 215 determines the user instruction via the screen control unit 211. If the instruction is to cancel (CANCEL in step S308), the processing ends. If the instruction is to start scanning the front side with the scan result order setting 423 turned ON (START FRONT-SIDE SCAN in step S308), the processing advances to step S309. If the instruction is to start scanning the back side with the scan result order setting 423 turned OFF, the processing advances to step S314.

In step S309, the ID card copy application 215 overwrites the data saved as the first image data in step S306 in the RAM 103 with the second image data and performs image order control.

In step S310, the ID card copy application 215 starts rescanning the first image (reacquisition of the first image) with the scanner 111 via the scanner control unit 212.

In step S311, the ID card copy application 215 stores, in the RAM 103, the first image data obtained by scanning in step S310.

In step S312, the ID card copy application 215 starts scanning the second image (acquisition of the second image) with the scanner 111 via the scanner control unit 212.

In step S313, the ID card copy application 215 stores, in the RAM 103, the second image data obtained by scanning in step S312.

In step S314, the ID card copy application 215 combines the data saved in the RAM 103 as the first image data in step S306 or step S311 and the data saved in the RAM 103 as the second image data in step S309 or step S315. The combined result is stored in the RAM 103 as an image to be output as the ID card copy result.

In step S315, the ID card copy application 215 starts printing the combined image data saved in the RAM 103 in step S314 (printing of the combined image) using the printer 112 via the printer control unit 213. Here, if the data saved as the first image data in step S311 is used, the first image is the reacquired image.

As described above, according to the present embodiment, by treating the first image data once saved as the front side as the second image data for the back side, rescanning is unnecessary even after scanning the front and back sides in the wrong order, thereby improving usability.

### Second Embodiment

In the first embodiment, the processing of the ID card copy application 215 is described as an example of rearranging the order of scanned image data. This is because, in the case of an ID card, only one side can be scanned at a time, and the situation described in the description of the related art is likely to occur since the combined image data must be output on one sheet. However, even in an ordinary copying case, a situation occur where one side is scanned at a time and the combined image data is output on one sheet.

Therefore, in a second embodiment, an example will be described in which the copy application 214 rearranges and outputs the order of scanned image data. The image data is assumed to be generated by reading a document placed on the document table.

Since the second embodiment is a modification of the first embodiment, only differences will be described.

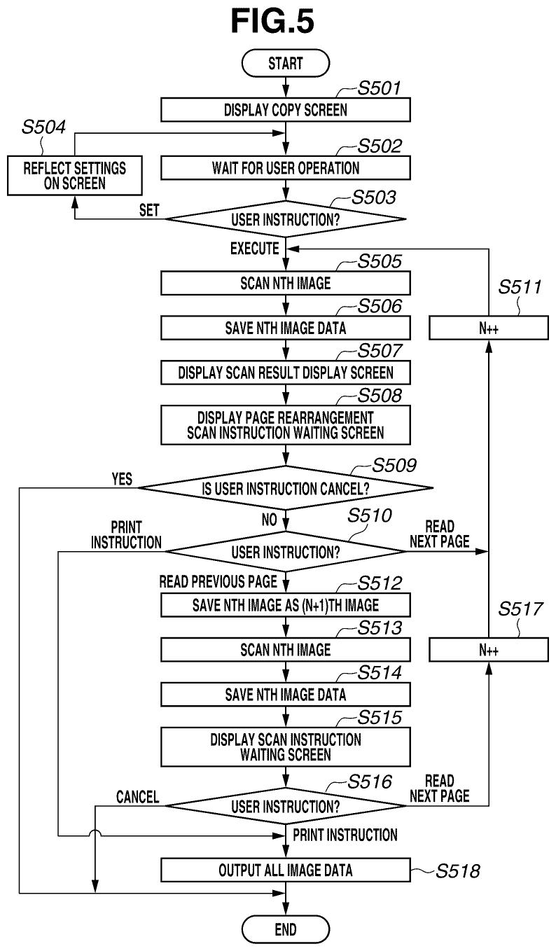

FIG. 5 is a flowchart illustrating processing of the copying function executed by the image forming apparatus 100 according to the present embodiment.

The flowchart in FIG. 5 is implemented by the CPU 102 of the image forming apparatus reading programs for implementing each software module stored in the ROM 104 or the HDD 105 into the RAM 103 and executing the programs.

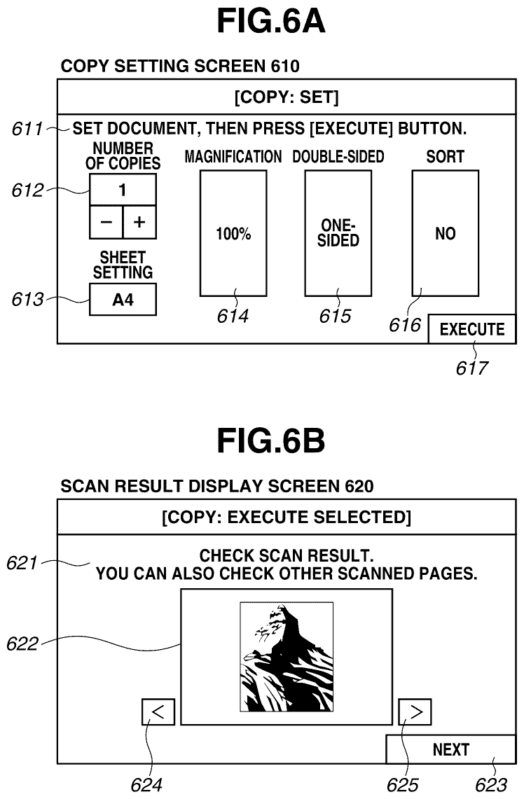

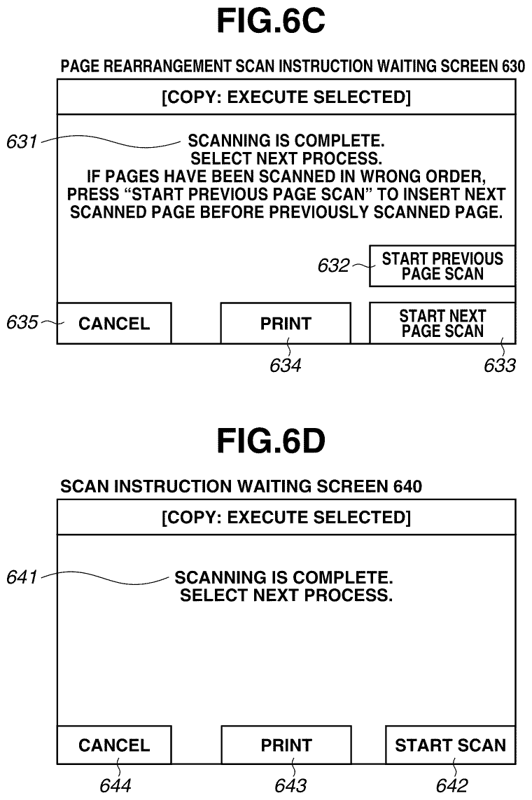

In step S501, the copy application 214 displays a copy setting screen 610 illustrated in FIG. 6A on the operation unit 107 via the screen control unit 211.

The copy setting screen 610 includes a message area 611, a copy count setting 612, a sheet size setting 613, a magnification setting 614, a duplex setting 615, a sort setting 616, and an execution button 617.

The message area 611 is an area for displaying messages that assist the user in operation.

The copy count setting 612 is a component for displaying and setting the number of copies to be printed. The user changes the setting for the number of copies using the “+” button and the “−” button.

The sheet size setting 613 is a component for displaying and setting the size of the print paper.

The sheet size setting 613 is a button that, when pressed, displays a screen (not shown) for selecting the print sheet size.

The magnification setting 614 is a component for displaying and setting the magnification. The magnification setting 614 is a button that, when pressed, displays a screen (not shown) for selecting the magnification value.

The duplex setting 615 is a component for displaying and setting duplex printing. The duplex setting 615 is a button that, when pressed, displays a screen (not shown) for selecting a duplex setting value.

The sort setting 616 is a component for displaying and setting sorting. The sort setting 616 is a button that, when pressed, displays a screen (not shown) for selecting a sort setting value.

Returning to the description of the flowchart, in step S502, the copy application 214 waits for user operation via the screen control unit 211.

In step S503, if the detected user instruction is “to set” (SET in step S503), the copy application 214 advances the processing to step S504. If the detected user instruction is “to execute” (EXECUTE in step S503), the copy application 214 advances the processing to step S505. The user instruction “to set” refers to operations for setting the copy function, such as increasing or decreasing the number of copies using the copy count setting 612 and selecting the sheet size on the screen (not shown) displayed after pressing the sheet size setting 613.

In step S504, the copy application 214 reflects the setting value(s) set by the user operation(s) on the screen, and the processing returns to step S502.

The user instruction “to execute” corresponds to pressing the execution button 617. For example, in addition to pressing the execution button 617, pressing the physical execution button provided on the operation unit 107 may also be acceptable.

In step S505, the copy application 214 starts scanning an Nth image with the scanner 111 via the scanner control unit 212. Here, when executing this processing for the first time, the variable N is set to 1 and stored in the RAM 103.

In step S506, the copy application 214 stores, in the RAM 103, the Nth image data obtained by scanning in step S505.

In step S507, the copy application 214 displays a scan result display screen 620 illustrated in FIG. 6B using the Nth image data saved in the RAM 103 in step S506.

The scan result display screen 620 includes a message area 621, a scan result display area 622, and a NEXT button 623.

The message area 621 is an area for displaying messages that assist the user in operation.

The scan result display area 622 displays the Nth image data saved in step S506. By pressing a previous button 624, the user can display image data from a first image to an (N−1)th image in the scan result display area 622.

The next button 625 displays image data scanned after the currently displayed image data in the scan result display area 622. This allows the user to check the result immediately after scanning. Therefore, if the user mistakenly scans the back side first, the user can quickly notice the error. By pressing the NEXT button 623, the processing advances to step S508.

Returning to the description of the flowchart, in step S508, the copy application 214 displays a page rearrangement scan instruction waiting screen 630 illustrated in FIG. 6C.

The page rearrangement scan instruction waiting screen 630 illustrated in FIG. 6C includes a message area 631, a previous page scan start button 632, a next page scan start button 633, a print button 634, and a cancel button 635.

The message area 631 is an area for displaying messages that assist the user in operation.

The previous page scan start button 632 is a button for starting scanning to overwrite the Nth image data saved in step S506 with a (N+1)th image data and save a next document as the Nth image data by performing image order control.

The next page scan start button 633 is a button for starting scanning to save a next document in normal order.

The print button 634 is a button for starting processing for printing the results scanned so far.

The cancel button 635 is a button for issuing an instruction to cancel a job.

Returning to the description of the flowchart, in step S509, the copy application 214 determines whether the user instruction on the page rearrangement scan instruction waiting screen 630 illustrated in FIG. 6C is to cancel. If the user instruction is to cancel (YES in step S509), the screen control unit 211 closes the page rearrangement scan instruction waiting screen 630 and ends the flowchart. If the user instruction is not to cancel (NO in step S509), the processing advances to step S510.

In step S510, the copy application 214 determines the user instruction on the page rearrangement scan instruction waiting screen 630. If the instruction is “to start next page scan” (READ NEXT PAGE in step S510), the processing advances to step S511. If the instruction is “to start previous page scan” (READ PREVIOUS PAGE in step S510), the processing advances to step S512. If the instruction is “to print” (PRINT INSTRUCTION in step S510), the processing advances to step S517.

In step S511, the copy application 214 increments the variable N by 1 (i.e., N+1), stores the value in the RAM 103, and the processing advances to step S505. This allows the user to proceed to scanning a next document in a case where the user has scanned the document in correct order.

In step S512, the copy application 214 overwrites the data saved as the Nth image data in step S506 in the RAM 103 with the (N+1)th image data.

In step S513, the copy application 214 starts scanning the Nth image with the scanner 111 via the scanner control unit 212.

In step S514, the copy application 214 stores the Nth image data obtained by scanning in step S513 in the RAM 103.

In step S515, the copy application 214 displays a scan instruction waiting screen 640 illustrated in FIG. 6D.

The scan instruction waiting screen 640 includes a message area 641, a scan start button 642, a print button 643, and a cancel button 644.

The message area 641 is an area for displaying messages that assist the user in operation.

The scan start button 642 is a button for starting scanning to save a next scanned document in normal order.

The print button 643 is a button for starting processing to print the scanned results so far.

The cancel button 644 is a button for issuing an instruction to cancel a job.

Returning to the description of the flowchart, in step S516, the copy application 214 determines the user instruction via the screen control unit 211. If the user instruction is “to scan the next page” (READ NEXT PAGE in step S516), the processing advances to step S517. If the user instruction is “to print” (PRINT INSTRUCTION in step S516), the processing advances to step S518. If the user instruction is “to cancel” (CANCEL in step S516), the screen control unit 211 closes the scan instruction waiting screen 640 and ends the flowchart.

In step S517, the copy application 214 increments the variable N by 1, stores the value in the RAM 103, and the processing advances to step S511. Through steps S512 to S517, when the user scans documents in the wrong order, the order of saving image data can be rearranged, eliminating the need to cancel the job.

In step S518, the copy application 214 starts printing all the pieces of image data saved from step S505 to step S514 in ascending order of image numbers using the printer 112 via the printer control unit 213.

As described above, according to the present embodiment, by changing the saving order of image data once saved and image data subsequently acquired, it is possible to eliminate the need for rescanning even after scanning in the wrong order, thereby improving usability.

The present disclosure is not limited to the above embodiments, and the embodiments can be modified in various ways based on the spirit of the present disclosure (including organic combinations of the respective embodiments), and such modifications are not excluded from the scope of the present disclosure. That is, configurations as combinations of the above-described embodiments and the modifications thereof are all included in the present disclosure.

According to the present disclosure, even when the front and back sides of a document are scanned in the wrong order, rescanning is unnecessary, improving usability.

### Other Embodiments

Embodiments of the present disclosure can also be realized by a computer of a system or apparatus that reads out and executes computer-executable instructions (e.g., one or more programs) recorded on a storage medium (which may also be referred to more fully as a “non-transitory computer-readable storage medium”) to perform the functions of one or more of the above-described embodiments and/or that includes one or more circuits (e.g., application-specific integrated circuit (ASIC)) for performing the functions of one or more of the above-described embodiments, and by a method performed by the computer of the system or apparatus by, for example, reading out and executing the computer-executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-220218, filed Dec. 16, 2024, which is hereby incorporated by reference herein in its entirety.

What is claimed is:

1. An image forming apparatus comprising:
at least one memory storing instructions; and
at least one processor that, upon execution of the stored instructions, configures the at least one processor to operate as:
a scanning unit configured to scan a document and generate image data;
a display unit configured to display first image data generated by scanning a front side of the document with the scanning unit, wherein the display unit displays an object for treating the first image data as back-side data while displaying the first image data; and
a control unit configured to, in response to selection of the object, treat second image data generated by scanning a back side of the document with the scanning unit as front-side data and treat the first image data as the back-side data.

2. The image forming apparatus according to claim 1, wherein the display unit displays the object in response to selection of an ID card copy function of the image forming apparatus.

3. The image forming apparatus according to claim 1, further comprising an acceptance unit configured to accept an operation for scanning the back side of the document with the scanning unit while the display unit displays the object.

4. A control method for an image forming apparatus, the control method comprising:
scanning a document and generating image data;
displaying first image data generated by scanning a front side of the document in the scanning, wherein an object for treating the first image data as back-side data is displayed while the first image data is displayed; and
controlling, in response to selection of the object, second image data generated by scanning a back side of the document in the scanning to be treated as front-side data and the first image data to be treated as the back-side data.

5. A non-transitory computer-readable storage medium storing a program for causing a computer to execute an image forming method, the image forming method comprising:
scanning a document and generating image data;
displaying first image data generated by scanning a front side of the document in the scanning, wherein an object for treating the first image data as back-side data is displayed while the first image data is displayed; and
controlling, in response to selection of the object, second image data generated by scanning a back side of the document in the scanning to be treated as front-side data and the first image data to be treated as the back-side data.
